(19) United States
(12) Patent Application Publication
(10) Pub. No.: US 2024/0409702 A1
(43) Pub. Date: Dec. 12, 2024

(54) COMPOSITE RESIN MOLDED BODY AND METHOD FOR PRODUCING SAME

(71) Applicant: Panasonic Intellectual Property Management Co., Ltd., Osaka (JP)

(72) Inventors: AMI FUKU, Osaka (JP); TOSHIFUMI NAGINO, Osaka (JP); MASASHI HAMABE, Osaka (JP); MASAYOSHI IMANISHI, Fukui (JP)

(21) Appl. No.: 18/811,840

(22) Filed: Aug. 22, 2024

Related U.S. Application Data
(63) Continuation of application No. PCT/JP2022/035258, filed on Sep. 21, 2022.

(30) Foreign Application Priority Data
Mar. 2, 2022 (JP) 2022-032076

(51) Int. Cl. C08J 5/06; B29C 70/46; B29K 201/00; C08J 5/04

(52) U.S. Cl. CPC C08J 5/06; B29C 70/465; C08J 5/045; B29K 2201/00

(57) ABSTRACT

A composite resin molded article containing: a base resin; and a plurality of natural fibers dispersed in the base resin, wherein at least a part of the plurality of natural fibers supports a spore and a nutrient, the plurality of natural fibers has a content of 10 mass % or more and 99 mass % or less based on 100 mass % of the composite resin molded article, and a part of the plurality of natural fibers is exposed on a surface of the composite resin molded article.

### TECHNICAL FIELD

The present disclosure relates to a composite resin molded article having excellent mechanical properties and a controlled biodegradation rate in a humid environment, and a method for producing the same.

### BACKGROUND ART

So-called “general-purpose plastics” such as polyethylene (PE), polypropylene (PP), polystyrene (PS), and polyvinyl chloride (PVC) are not only very inexpensive but also easy to mold, and have a weight as small as a fraction of that of metal or ceramics. Therefore, general-purpose plastics are often used as materials of various daily commodities such as bags, various packaging, various containers, and sheets, and as materials for industrial components such as automobile components and electrical components, daily necessities, and miscellaneous goods.

Under such circumstances, the amount of plastic waste after use is increasing year by year, and plastic waste, which is a substance having a property of being hardly decomposed, accumulates in a natural environment and causes pollution problems such as destruction and pollution in the natural environment. In recent years, biodegradable plastics that are decomposed into water and carbon dioxide in the natural environment have been proposed as one of measures to solve such various problems, and expanded use of the biodegradable plastics instead of general-purpose plastics produced using petroleum-based raw materials is expected.

However, biodegradable plastics have disadvantages such as insufficient mechanical strength as compared with general-purpose plastics. Therefore, biodegradable plastics do not have sufficient properties required for materials used for machine products such as automobiles and various industrial products including electric/electronic/information products, and the application range thereof is currently limited.

On the other hand, the biodegradation rate of the biodegradable plastics after disposal is greatly affected by the environment. In an environment with a small number of microorganisms, such as in the ocean, it takes significantly long time to completely decompose the biodegradable plastics, and the properties of biodegradability are not sufficiently utilized. In order to solve such problems, various methods have been proposed to accelerate the decomposition of the biodegradable plastics after disposal.

In order to solve such problems, a product obtained by combining a biodegradable plastic with a microorganism having an enzyme activity of decomposing the material (see, for example, PTL 1), and a method of combining spores which are cellular structures exhibiting high durability against stress from the outside such as high temperature conditions are disclosed (see, for example, PTL 2).

### CITATION LIST

### Patent Literature

PTL 1: Unexamined Japanese Patent Publication No. 2013-209587
PTL 2: PCT International Publication No. 2013/180124

### SUMMARY OF THE INVENTION

A composite resin molded article according to one aspect of the present disclosure is a composite resin molded article containing: a base resin; and a plurality of natural fibers dispersed in the base resin, wherein at least a part of the plurality of natural fibers supports a spore and a nutrient, the plurality of natural fibers includes a content of 10 mass % or more and 99 mass % or less based on 100 mass % of the composite resin molded article, and a part of the plurality of natural fibers is exposed on a surface of the composite resin molded article.

A method for producing a composite resin molded article according to one aspect of the present disclosure includes: a step of preparing a spore, a nutrient, a natural fiber, and a base resin; a step of supporting the spore and the nutrient on the natural fiber; a step of melt-kneading the natural fiber on which the spore and the nutrient are supported, together with the base resin to promote defibration of the natural fiber from an end portion in a fiber length direction, thus obtaining a composite resin material having a defibrated portion of the end portion, the defibrated portion having an enlarged specific surface area; and a step of molding the composite resin material to obtain a composite resin molded article.

### BRIEF DESCRIPTION OF THE DRAWINGS

FIG. 1 is a schematic view illustrating a cross-sectional structure of a composite resin molded article according to the exemplary embodiment.

FIG. 2 is a schematic view illustrating a cross-sectional structure of a natural fiber that is a constituent member of the composite resin molded article according to the exemplary embodiment.

FIG. 3 is a schematic cross-sectional view of a composite resin molded article containing a natural fiber having a defibrated site according to the exemplary embodiment.

FIG. 4 is a schematic diagram of a production process for the composite resin molded article according to the exemplary embodiment.

FIG. 5 is a table showing configurations and measurement results of composite resin molded articles in examples and comparative examples in the exemplary embodiment.

### DESCRIPTION OF EMBODIMENTS

In the method described in PTL 1, since the microorganism is directly kneaded into the biodegradable plastic, the material is limited to biodegradable plastics that can be molded at a temperature at which the microorganism can survive.

On the other hand, the method described in PTL 2 has a problem that the molded article needs to be physically broken in order for the spores to come into contact with water and germinate.

One aspect of the present disclosure is to solve the above-described conventional problems, and an object of the present disclosure is to provide a composite resin molded article that maintains high rigidity during use and promotes biodegradation in a humid environment such as in the ocean or the soil after disposal.

A composite resin molded article according to a first aspect of the present disclosure is a composite resin molded article containing: a base resin; and a plurality of natural fibers dispersed in the base resin, wherein at least a part of the plurality of natural fibers supports a spore and a nutrient, the plurality of natural fibers has a content of 10 mass % or more and 99 mass % or less based on 100 mass % of the composite resin molded article, and a part of the plurality of natural fibers is exposed on a surface of the molded article.

In the composite resin molded article according to a second aspect, in the first aspect, the at least a part of the plurality of natural fibers may have a moisture content, as measured by a method defined in JIS L0105:2020, of 5% or more.

In the composite resin molded article according to a third aspect, in the first or second aspect, the base resin may be a biodegradable resin containing any one selected from the group consisting of a polyhydroxy acid, a polyhydroxyalkanoate, a polyalkylene dicarboxylate, and a modified starch.

In the composite resin molded article according to a fourth aspect, in any one of the first to third aspects, the nutrient may contain any one of peptones and extracts.

In the composite resin molded article according to a fifth aspect, in any one of the first to fourth aspects, the at least a part of the plurality of natural fibers may support a spore and a nutrient on a surface of the at least a part of the plurality of natural fibers.

In the composite resin molded article according to a sixth aspect, in any one of the first to fifth aspects, the at least a part of the plurality of natural fibers may be celluloses.

In the composite resin molded article according to a seventh aspect, in any one of the first to sixth aspects, the at least a part of the plurality of natural fibers may have a defibrated site at an end portion in a fiber length direction.

A method for producing a composite resin molded article according to an eighth aspect includes: a step of preparing a spore, a nutrient, a natural fiber, and a base resin; a step of supporting the spore and the nutrient on the natural fiber; a step of melt-kneading the natural fiber on which the spore and the nutrient are supported, together with the base resin to promote defibration of the natural fiber from an end portion in a fiber length direction, thus obtaining a composite resin material having a defibrated portion of the end portion, the defibrated portion having an enlarged specific surface area; and a step of molding the composite resin material to obtain a composite resin molded article.

Hereinafter, a composite resin molded article according to an exemplary embodiment and a method of producing the same will be described with reference to the accompanying drawings. In the following description, the same components are denoted by the same reference marks, and the description thereof is appropriately omitted.

### Exemplary Embodiment

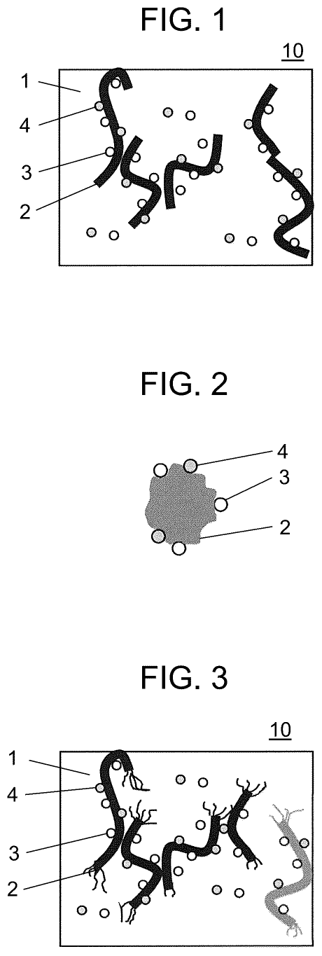

FIG. 1 is a schematic view illustrating a cross-sectional structure of composite resin molded article 10 according to the exemplary embodiment. FIG. 2 is a schematic view illustrating a cross-sectional structure of a natural fiber that is a constituent member of composite resin molded article 10 according to the exemplary embodiment.

Composite resin molded article 10 according to the exemplary embodiment is formed of a melt-kneaded product of base resin 1 and natural fiber 2 on which spore 3 and nutrient 4 are supported. In composite resin molded article 10, as illustrated in the schematic view illustrating the cross-sectional structure of FIG. 1, natural fibers 2 on which spore 3 and nutrient 4 are supported are dispersed in base resin 1.

At least one natural fiber 2 is exposed on the surface of composite resin molded article 10.

Further, as illustrated in the schematic view illustrating the cross-sectional structure of composite resin molded article 10 containing natural fiber 2 having a defibrated site according to the exemplary embodiment of FIG. 3, providing a defibrated site at the end portion of natural fiber 2 increases the specific surface area of the defibrated site, and increases the number of contact points between natural fibers 2. As a result, water can be absorbed into the inside of composite resin molded article 10 via the contact points between natural fibers 2 in a humid environment.

According to composite resin molded article 10, since at least one natural fiber 2 is exposed on a surface of the composite resin molded article, and natural fibers 2 have contact points with each other, the composite resin molded article has high elastic modulus and high water absorbency. In a humid environment, spore 3 germinates due to the water absorption of natural fiber 2 to promote the decomposition of base resin 1. Therefore, it is possible to realize composite resin molded article 10 which maintains high rigidity during use and has excellent biodegradability in a humid environment such as in the ocean or the soil after disposal.

Hereinafter, each member constituting the composite resin molded article will be described.

### <Base Resin>

In the present exemplary embodiment, base resin 1 is preferably a biodegradable plastic containing any one selected from the group consisting of a polyhydroxy acid, a polyhydroxyalkanoate, a polyalkylene dicarboxylate, and a modified starch. Further, in order to ensure good moldability, a thermoplastic resin is preferable, and the above resins may be used alone or in combination of two or more thereof. Note that base resin 1 is not limited to the above materials as long as it has biodegradability.

In the present exemplary embodiment, the term “biodegradable plastic” refers to “resin that has a function similar to that of a conventional petroleum-derived resin at the time of use, and is finally decomposed into water and carbon dioxide by microorganisms in the soil and the ocean in nature after use”. Specific examples of the biodegradable plastic include polyhydroxyalkanoates such as polyhydroxybutyrate and polyhydroxyvalerate; polyhydroxy acids such as polylactic acid, polyglycolic acid, and polycaprolactone; polyester-based resins including polyalkylene dicarboxylates such as polybutylene adipate terephthalate, polyethylene succinate, and polybutylene succinate; polyamides; and modified starches. Examples of the biodegradable plastic include, in addition to a homopolymer of a monomer of the resins described above, a copolymer of a monomer, such as poly(3-hydroxybutyrate-co-3-hydroxyvalerate), and a copolymer of a monomer and another copolymerizable monomer.

### <Natural Fiber>

Next, natural fiber 2 will be described. The main first purpose of adding natural fiber 2 (hereinafter, may be simply referred to as “fiber”) contained in composite resin molded article 10 in the present exemplary embodiment is to cause composite resin molded article 10 to absorb water in the soil and the ocean without imposing a load on the environment when composite resin molded article 10 is discarded after use, to thereby bring spore 3 into contact with water and germinate spore 3. For this purpose, natural fiber 2 preferably has high water absorbency, and the moisture content of natural fiber 2 is preferably 5% or more by a method defined in JIS L0105:2020. Specifically, pulp, cellulose, cellulose nanofibers, lignocellulose, lignocellulose nanofibers, cotton, silk, and hemp are preferable.

The second purpose of adding natural fiber 2 is to improve mechanical properties and to improve dimensional stability by decreasing the linear expansion coefficient. For this purpose, natural fiber 2 preferably has a higher elastic modulus than base resin 1. Specific examples thereof include pulp, cellulose, cellulose nanofibers, lignocellulose, lignocellulose nanofibers, cotton, silk, wool, and hemp. Further, among them, celluloses are particularly preferable from the viewpoint of availability, high elastic modulus, and low linear expansion coefficient. Note that natural fiber 2 is not limited to the above materials as long as it can improve mechanical properties and has water absorbency.

After spore 3 and nutrient 4 are supported on natural fiber 2, the content of natural fiber 2 on which spore 3 and nutrient 4 are supported in composite resin molded article 10 is preferably 10 mass % or more and 99 mass % or less based on 100 mass % of composite resin molded article 10. When the content of natural fiber 2 on which spore 3 and nutrient 4 are supported is less than 10 mass %, natural fibers 2 are less likely to have a contact point with each other in composite resin molded article 10, and thus sufficient water absorbency is not attained. On the other hand, when the content of natural fiber 2 on which spore 3 and nutrient 4 are supported is more than 99 mass %, the proportion of base resin 1 decreases, so that the effect of bonding natural fibers 2 to each other is lost and moldability is thus deteriorated.

The form of natural fiber 2 in composite resin molded article 10 will be described. In order to improve the water absorbency of composite resin molded article 10, a part of natural fiber 2 is preferably exposed on the surface of composite resin molded article 10. Since a part of natural fiber 2 is exposed on the surface of composite resin molded article 10, water is absorbed from an exposed portion of natural fiber 2, and water is absorbed into the inside of composite resin molded article 10 by a capillary phenomenon of fibers constituting the natural fiber. The exposed portion of natural fiber 2 exposed on the surface of the composite resin molded article has higher water absorbency as the specific surface area is smaller. This is because when the specific surface area of the exposed portion of natural fiber 2 exposed on the surface is large, water repellency is enhanced by the effect of fine irregularities. Further, as illustrated in FIG. 3, by having a defibrated site at an end portion of natural fiber 2, the specific surface area of the defibrated site increases, and the number of contact points between natural fibers 2 increases, so that the water absorption rate can be increased via the contact points of natural fibers 2 in a humid environment.

The central portion of natural fiber 2, which has a small specific surface area and is not defibrated, is less entangled with base resin 1 and is easily exposed to the surface of the composite resin molded article depending on the molding conditions. On the other hand, the tip portion of defibrated natural fiber 2 is highly entangled with base resin 1, and enters the inside together with base resin 1. As a result, it is possible to obtain composite resin molded article 10 in which the central portion not including both ends of natural fiber 2 is exposed to the surface.

The total length of the tip defibrated sites at both ends of natural fiber 2 is preferably 5% or more and 50% or less of fiber length L of entire natural fiber 2. When the length of the defibrated site is less than 5% of total fiber length L, the elastic modulus is not improved because the specific surface area is small, and when the length of the defibrated site is more than 50%, the defibrated site having a high aspect ratio is exposed on the surface of the composite resin molded article, so that water absorbency is deteriorated.

Next, properties of natural fiber 2 will be described. The types of base resin 1 and natural fiber 2 are as described above, but when natural fiber 2 is too soft, that is, has a small elastic modulus with respect to base resin 1, composite resin molded article 10 has a small elastic modulus as a whole, resulting in a decrease in strength. On the other hand, when natural fiber 2 is too hard, that is, has a large elastic modulus with respect to base resin 1, shock waves generated at the time of impact are not propagated but absorbed at the interface between base resin 1 and natural fiber 2, so that cracks and creases are likely to occur in the vicinity of the interface, and as a result, impact strength is deteriorated. Therefore, in the relationship between the elastic modulus of base resin 1 and the elastic modulus of natural fiber 2, the elastic modulus of natural fiber 2 is higher than the elastic modulus of base resin 1, and the difference between the elastic moduli is preferably as small as possible. The optimum relationship is calculated from simulation results, and the difference in elastic modulus between base resin 1 and natural fiber 2 is preferably within 20 GPa.

Further, these natural fibers 2 may be subjected to a surface treatment for the purpose of, for example, improving adhesion to base resin 1 or dispersibility in composite resin molded article 10, but when the water absorbency of natural fibers 2 is impaired by the surface treatment, it is preferable not to perform the surface treatment in advance.

### <Additive>

An additive may be used as necessary. For example, a compatibilizer for improving the affinity between base resin 1 and natural fiber 2 may be added, or natural fiber 2 may be coated with a water-soluble or hydrolyzable resin for the purpose of protecting spore 3 and nutrient 4 contained in natural fiber 2. This makes it possible to protect spores and nutrients from thermal damage from the molten base resin even during melt-kneading in the production stage of the composite resin molded article. Note that additives that are usually used can be used.

### <Spore>

Next, spore 3 will be described. The spore is a durable cell having a highly durable cellular structure formed by bacteria when the growth environment of the bacteria deteriorates. The spore may also be referred to as an endospore. Spore 3 in the present exemplary embodiment is used for the purpose of accelerating the decomposition of composite resin molded article 10 in a humid environment. Specific examples of spore 3 in the present exemplary embodiment include spores of Bacillus bacteria, Paenibacillus bacteria, Brevibacillus bacteria, Clostridium bacteria, and Sporosarcina bacteria. Examples of spores for decomposing biodegradable plastics such as aliphatic polyester and aliphatic-aromatic polyester include spores of Bacillus bacteria, Paenibacillus bacteria, and Brevibacillus bacteria. The above-described spores may be used alone or in combination of two or more thereof. Note that spore 3 is not limited to the above materials as long as it is a spore of a species that has decomposability with respect to base resin 1, and that forms spores.

### <Nutrient>

Next, nutrient 4 will be described. Nutrient 4 in the present exemplary embodiment is used for the purpose of promoting germination of spore 3 in a humid environment. Nutrient 4 in the present exemplary embodiment is preferably peptones or extracts serving as a phosphorus source, a sulfur source, a mineral source, or a vitamin source in order to promote absorption of nutrients by microorganisms. Examples of the peptones include casein peptone, meat peptone, fungal peptone, and soybean peptone. Examples of the extracts include meat extract, yeast extract, malt extract, and potato extract. The above-described nutrients may be used alone or in combination of two or more thereof. Nutrient 4 is not limited to the above materials as long as it has a component that promotes germination of spores.

### <Method of Producing Composite Resin Molded Article>

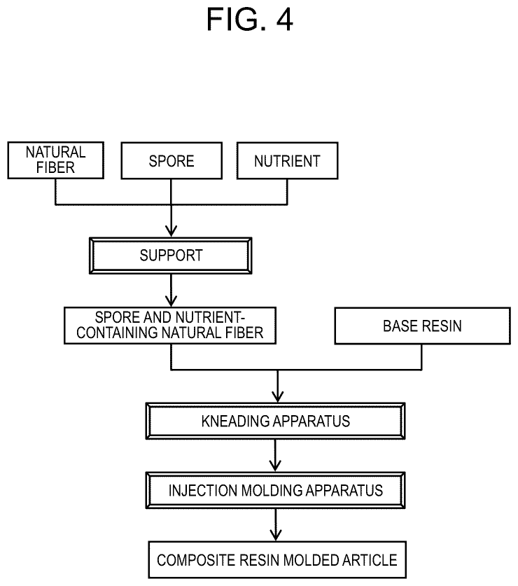

Next, a method of producing composite resin molded article 10 according to the exemplary embodiment will be described. FIG. 4 is a flowchart illustrating a production process of composite resin molded article 10 according to the present exemplary embodiment.

(1) Spore 3 and nutrient 4 are supported on the surface of natural fiber 2 in advance. Examples of the method for supporting spore 3 and nutrient 4 include physical adsorption by dry blending, an impregnation method of natural fibers using a dispersion solvent, a crosslinking method, and an entrapment method. The method for supporting spore 3 and nutrient 4 is not limited to the above-described methods as long as it is a method capable of holding spore 3 and nutrient 4 on the surface of natural fiber 2.

(2) Base resin 1 and natural fiber 2 on which spore 3 and nutrient 4 are supported are dry-blended, and then the mixture is fed into a melt-kneading apparatus and melt-kneaded in the apparatus. A part of spore 3 and nutrient 4 supported on natural fiber 2 falls off from natural fiber 2 and is dispersed in base resin 1. The shearing action of the apparatus promotes defibration of aggregates of natural fibers 2, and natural fibers 2 can be finely dispersed in base resin 1. At this time, by adjusting the shear conditions, as illustrated in FIG. 3, the end portion of natural fiber 2 is defibrated, and it is also possible to obtain a defibrated site. For example, as shown in Example 1 described later, under the condition of a material temperature of 180° C. for about 5 minutes, it is considered that spores and nutrients are not thermally damaged from the molten base resin.

Conventionally, when fibers are combined with a resin, fibers that have been defibrated in advance by a pretreatment such as wet dispersion have been used. However, when the natural fibers are defibrated in a solvent used in wet dispersion, the fibers swells due to the solvent. Therefore, in order for the natural fibers to sufficiently absorb water and expand in the composite resin molded article, the solvent in the natural fibers needs to be dried before being kneaded with the base resin. Further, in the defibration by wet dispersion, the fibers are easier to be defibrated than to be defibrated in the molten base resin, so that it is difficult to defibrate only the end portion, and the entire natural fiber is defibrated. In addition, there is a problem that the number of processes increases and productivity deteriorates by combining the pretreatment.

On the other hand, in the process of producing composite resin molded article 10 according to the present exemplary embodiment, a melt-kneading treatment (all-dry method) is performed together with base resin 1 without performing a pretreatment by wet dispersion for the purpose of defibrating natural fiber 2. In this method, since the wet dispersion treatment of natural fiber 2 is not performed, swelling of natural fiber 2 in the production process is suppressed, and the water absorption rate of natural fiber 2 in composite resin molded article 10 can be improved. By subjecting natural fiber 2 to a drying treatment in advance or during kneading, the water absorption rate in a humid environment in composite resin molded article 10 can be further improved. When natural fiber 2 has a defibrated site as described above, the fibers have many contact points inside composite resin molded article 10, and the water absorption rate of composite resin molded article 10 can be increased via the contact points between the fibers.

In order to produce natural fiber 2 of the present exemplary embodiment by the all-dry method, it is preferable to apply high shear stress during kneading. Specific examples of the kneading method include a single screw kneader, a twin screw kneader, a roll kneader, a Banbury mixer, and a combination thereof. From the viewpoint of easy application of high shear and high mass productivity, a continuous twin screw kneader and a continuous roll kneader are particularly preferable. A kneading method other than the above may be used as long as high shear stress can be applied.

(4) By injection-molding the composite resin composition extruded from the melt-kneading apparatus, composite resin molded article 10 as an injection-molded article can be produced.

Hereinafter, examples and comparative examples in experiments performed by the inventors will be described.

### Example 1

In Example 1, a cellulose composite poly(3-hydroxybutyrate-co-3-hydroxyvalerate) (PHBV) resin molded article was produced by the following production method.

Softwood pulp (product name: NBKP Celgar, manufactured by Mitsubishi Paper Mills Limited) was used as a starting material for the natural fiber. A spore formed by Bacillus bacteria was used as a PHBV-degrading spore. Casein peptone (manufactured by Nacalai Tesque, Inc.) was used as a nutrient. The softwood pulp, spore, and nutrient were dry-blended at a mass ratio of 97.8:1.1:1.1 to obtain a cellulose filler on which spores and nutrients were supported.

The cellulose filler on which spores and nutrients were supported, and PHBV (product name: Y1000P manufactured by TianAn Biopolymer) as a base resin were weighed at a mass ratio of 90:10, and then dry-blended. Thereafter, the mixture was melt-kneaded with a twin screw kneader (KRC kneader manufactured by Kurimoto, Ltd.). A screw was of a medium shear type. The conditions of the melt-kneading were a material temperature of 180° C. and a rotation speed of 50 min⁻¹. The composite resin composition discharged from the twin screw kneader was hot-cut to obtain cellulose composite PHBV resin pellets in which the mass ratio of the base resin, the natural fiber, the spore, and the nutrient was 10:88:1:1.

Thereafter, a test piece of a cellulose composite PHBV resin molded article was produced by an injection molding machine (180AD manufactured by The Japan Steel Works, Ltd.). The preparation conditions of the test piece were a base resin temperature of 200° C., a mold temperature of 50° C., an injection speed of 100 mm/s, and a holding pressure of 100 Pa. At this time, the total heating time in the melt-kneading and injection molding was set to 5 minutes or less. The shape of the test piece was changed according to the evaluation items described below.

### (Evaluation of Water Absorbency of Fiber)

The water absorbency of the fiber was evaluated by measuring the moisture content of the fiber according to the method defined in JIS L0105:2020. Specifically, the weight of the fiber dried at 80° C. for 24 hours was measured and taken as a reference weight. Thereafter, the weight of the fiber maintained at a temperature of 20° C. and a humidity of 65% for 24 hours was measured. The moisture content was calculated using the weight increase increased from the reference weight as moisture. A sample having a moisture content of less than 5% was rated as B, and a sample having a moisture content of 5% or more was rated as A. In the composite resin molded article according to Example 1, the moisture content of the softwood pulp was 6.5%, and the evaluation thereof was A.

### (Fiber End Portion Defibration)

The obtained cellulose composite PHBV resin molded article was immersed in chloroform to dissolve PHBV, and the shape of the remaining cellulose fibers was observed by SEM. In the composite resin molded article according to Example 1, the end portion of the fiber was in a defibrated state.

### (Evaluation of Elastic Modulus of Composite Resin Molded Article)

A three-point bending test was performed using the obtained dumbbell-shaped test piece of JIS K7139 type A12 size. Here, as a method for evaluating the elastic modulus, a sample having a numerical value of less than 200 MPa was rated as B, and a sample having a numerical value of 200 MPa or more was rated as A. In the composite resin molded article according to Example 1, the elastic modulus of the test piece was 683 MPa, and the evaluation thereof was A.

### (Evaluation of Biodegradability of Composite Resin Molded Article)

A biodegradation test was performed using a bar-shaped test piece formed of the obtained cellulose composite resin molded article. Into a plastic container, 50 g of a compost planting source (YK-11 manufactured by Yawata Corporation) was placed, a bar-shaped test piece having a height of 20 mm, a width of 10 mm, and a thickness of 3 mm, the weight of which was measured in advance, was embedded in the planting source, this was held at a temperature of 58° C. and a humidity of 50%, and the weight loss after 2 months was evaluated. As a method for evaluating the biodegradation percentage, a sample having a weight loss value of 50% or more was rated as AA, a sample having a numerical value of weight loss of 40% or more and less than 50% was rated as A, and a sample having a weight loss value of less than 40% was rated as B. In the composite resin molded article according to Example 1, the biodegradation percentage of the test piece was 42%, and the evaluation thereof was A.

### Example 2

In Example 2, a cellulose composite PHBV resin molded article was produced under the same material conditions and process conditions as in Example 1 except that the mass ratio of the base resin, the natural fiber, the spore, and the nutrient was changed to 60:38:1:1. The evaluation was performed in the same manner as in Example 1.

### Comparative Example 1

In Comparative Example 1, a PHBV resin molded article was produced under the same material conditions and process conditions as in Example 1 except that the natural fiber was not used, and the mass ratio of the base resin, the spore, and the nutrient was changed to 98:1:1. The evaluation was performed in the same manner as in Example 1.

### Comparative Example 2

In Comparative Example 2, a PET fiber on which spores and nutrients were supported was produced using a PET fiber having a fiber diameter of 20 m and a fiber length of 100 m instead of softwood pulp. A PET fiber composite PHBV resin molded article was produced under the same material conditions and process conditions as in Example 1 except for the above. The evaluation was performed in the same manner as in Example 1.

### Comparative Example 3

In Comparative Example 3, a cellulose composite PHBV resin molded article was produced under the same material conditions and process conditions as in Example 1 except that the nutrient was not used, and the mass ratio of the base resin, the natural fiber, and the spore was changed to 11:88:1. The evaluation was performed in the same manner as in Example 1.

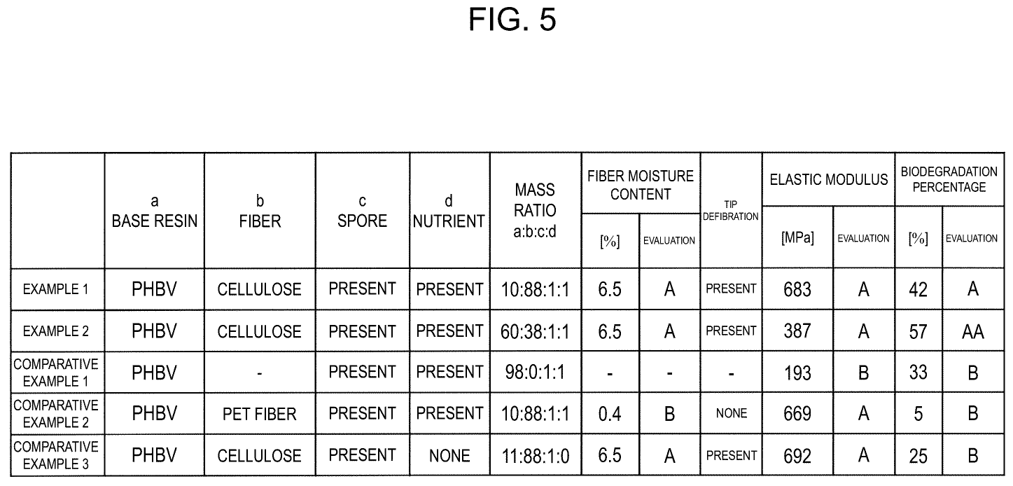

FIG. 5 shows the configurations and measurement results of the composite resin molded articles in Examples 1 and 2 and Comparative Examples 1 to 3.

As is apparent from FIG. 5, in Examples 1 and 2 in which spores and nutrients were supported on the natural fiber, the elastic modulus was as high as 200 MPa or more, and Example 1 in which the proportion of the natural fiber was large showed a higher elastic modulus as compared with Example 2. The biodegradation was promoted as compared with Comparative Example 1.

As described above, it was confirmed that a composite resin having high elastic modulus and high biodegradability was obtained when natural fibers on which spores and nutrients were supported were composited, the fibers were exposed on the surface of the composite resin molded article, and the water absorption rate of the natural fibers was high.

In Comparative Example 1 produced without using natural fibers, the elastic modulus was decreased, and the evaluation thereof was B. Water absorption into the inside of the composite resin molded article by natural fibers did not proceed, so that the germination of spores did not proceed, the biodegradation rate was decreased as compared with Example 1, and the evaluation was B.

In Comparative Example 2 produced using PET fibers instead of softwood pulp, the moisture content of the PET fibers was low and the water absorbency was absent, so that the germination of spores did not proceed in the biodegradability evaluation, the biodegradation rate was decreased as compared with Example 1, and the evaluation was B.

In Comparative Example 3 produced without using nutrients, the germination of spores did not proceed, the biodegradation rate was decreased as compared with Example 1, and the evaluation was B.

From the above evaluations, it was confirmed that a composite resin molded article having high elastic modulus and high biodegradability was obtained when natural fibers having water absorbency and biodegradable plastics were used, spores and nutrients were supported on the surface of natural fibers, and the fibers were exposed on the surface of the composite resin molded article.

Note that the present disclosure includes appropriate combination of arbitrary exemplary embodiments and/or examples among the various exemplary embodiments and/or examples described above, and effects of the respective exemplary embodiments and/or examples can be exhibited.

According to the composite resin molded article according to one aspect of the present disclosure, it is possible to realize a composite resin molded article having high elastic modulus and accelerated biodegradation rate in a humid environment as compared with a resin alone.

### INDUSTRIAL APPLICABILITY

The composite resin molded article according to one aspect of the present disclosure, it is possible to provide a composite resin molded article capable of controlling mechanical strength and biodegradation rate more than conventional biodegradable plastics. Since the properties of the base resin can be improved by one aspect of the present disclosure, the composite resin molded article according to one aspect of the present disclosure can be used as an alternative to petroleum-derived general-purpose plastics. Therefore, the environmental load of various industrial products or daily commodities made of petroleum-derived general-purpose plastics can be significantly reduced. Further, the composite resin molded article according to one aspect of the present disclosure can be used for packaging materials, daily necessities, housings for household electric appliances, building materials, and the like.

### REFERENCE MARKS IN THE DRAWINGS

1: base resin
2: natural fiber
3: spore
4: nutrient
10: composite resin molded article

1. A composite resin molded article comprising:
a base resin; and
a plurality of natural fibers dispersed in the base resin, wherein
at least a part of the plurality of natural fibers supports a spore and a nutrient,
the plurality of natural fibers includes a content of 10 mass % or more and 99 mass % or less based on 100 mass % of the composite resin molded article, and
a part of the plurality of natural fibers is exposed on a surface of the composite resin molded article.

2. The composite resin molded article according to claim 1, wherein the at least a part of the plurality of natural fibers has a moisture content, as measured by a method defined in JIS L0105:2020, of 5% or more.

3. The composite resin molded article according to claim 1, wherein the base resin is a biodegradable resin containing any one selected from the group consisting of a polyhydroxy acid, a polyhydroxyalkanoate, a polyalkylene dicarboxylate, and a modified starch.

4. The composite resin molded article according to claim 1, wherein the nutrient contains any one of peptones and extracts.

5. The composite resin molded article according to claim 1, wherein the at least a part of the plurality of natural fibers supports the spore on a surface of the at least a part of the plurality of natural fibers.

6. The composite resin molded article according to claim 1, wherein the at least a part of the plurality of natural fibers is a cellulose.

7. The composite resin molded article according to claim 1, wherein the at least a part of the plurality of natural fibers has a defibrated site at an end portion in a fiber length direction.

8. A method for producing a composite resin molded article, the method comprising:
a step of preparing a spore, a nutrient, a natural fiber, and a base resin;
a step of supporting the spore and the nutrient on the natural fiber;
a step of melt-kneading the natural fiber on which the spore and the nutrient are supported, together with the base resin to promote defibration of the natural fiber from an end portion in a fiber length direction, thus obtaining a composite resin material having a defibrated portion of the end portion, the defibrated portion having an enlarged specific surface area; and
a step of molding the composite resin material to obtain a composite resin molded article.
